(19) United States
(12) Patent Application Publication
(10) Pub. No.: US 2014/0009473 A1
(43) Pub. Date: Jan. 9, 2014

(54) METHOD, DEVICE AND SYSTEM FOR TRANSMITTING MEASUREMENT RESULT OF MEASURING DEVICE TO INFORMATION SYSTEM

(71) Applicant: Samsung Electronics Co., Ltd, Gyeonggi-do (KR)

(72) Inventor: Tymur Korkishko, Gyeonggi-do (KR)

(21) Appl. No.: 13/935,466

(22) Filed: Jul. 3, 2013

(30) Foreign Application Priority Data
Jul. 3, 2012 (KR) 10-2012-0072444

(51) Int. Cl. G06T 11/20

(52) U.S. Cl. CPC G06T 11/206
USPC 345/440

(57) ABSTRACT

An interface method for a measuring device includes: generating, by a portable device, an image including at least one of a measurement result and identification label of the measuring device using a camera; extracting, by the portable device, at least one of the measurement result and identification label of the measuring device from the generated image; and transmitting, by the portable device, the at least one of the extracted measurement result and identification label of the measuring device to an information system for managing measurement data.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Jul. 3, 2012 and assigned Serial No. 10-2012-0072444, the contents of which are incorporated herein by reference.

### TECHNICAL FIELD

The present disclosure relates generally to an interface for a measuring device. In particular, the present disclosure relates to an interface for a measuring device that displays a measurement result on the display of a portable device for information collection in digits, for example, in human-readable format.

### BACKGROUND

A medical measuring device has been widely used for medical practices. For example, the medical measuring device measures body temperature, blood pressure, heart rate, weight, height, blood sugar or the like. Most of current medical measuring devices provide a measurement result in a digital format, thereby allowing a user to easily recognize the measurement result.

A health information system uses various medical devices in order to collect, store, analyze and transmit information about various necessary parameters related to a user. Typical examples for such a system are disclosed in U.S. Publication No. 2010/0222645A1, U.S. Pat. No. 7,956,727, U.S. Publication No. 2011/0257989A1, and U.S. Pat. No. 8,015,026. Such a system provides a method for managing the system and health information. However, a specific mechanism for collection of health data has not been provided.

As another technology in medical devices, there is a special communication interface for transmitting a measurement result to the health information system. Generally, such an interface is firmly associated with a medical center which operates a health information system. Accordingly, it is considerably difficult to use the interface at home because of the expensive cost of the health information system's equipment and special training required to operate the equipment.

Most of medical measuring devices for use other than for a medical center are optimized for cost and, therefore, provide limited functions to a user. That is, special training is not required to display a measurement result and operate the device. Also, the measuring device measures only one thing for example, weight or body temperature. However, there is also a measuring device for performing different measurements. For example, the measuring device measures artery blood pressure and heart rate. On the order hand, the device does not include an interface suitable to transmit measurement information to the health information system. Limits in the medical devices for providing only a measurement result to a user are represented in a large number of medical devices.

Since measuring devices have been generally and widely used in many homes, to use the devices for providing measurement data to the health information system is benefit to both the user of the device and the health information system.

However, because the measuring device has not provided a method for convenient collection of measurement result, it is difficult to use a medical measuring device in order to provide data to a health information system with the purpose of use other than for a medical center. Cost increases to provide a special communication interface to the measuring device. In addition, special training is required for a user. Implementing the solutions decreases attraction to use the measuring device at home.

### SUMMARY

To address the above-discussed deficiencies, embodiments of the present disclosure provide a method, device and system for transmitting the measurement result of a measuring device to an information system.

Embodiments of the present disclosure provide a method and device for performing interface between a health information system and a medical device without requiring the special training of a user.

According to certain embodiments of the present disclosure, an interface method for a measuring device includes: generating, by a portable device, an image including at least one of a measurement result and identification label of the measuring device using a camera; extracting, by the portable device, at least one of the measurement result and identification label of the measuring device from the generated image; and transmitting, by the portable device, the at least one of the extracted measurement result and identification label of the measuring device to an information system for managing measurement data.

According to certain embodiments of the present disclosure, an interface method for a measuring device includes: acquiring an identification label by a measuring device; and the measuring device, performing, by the measuring device, a corresponding measurement process and outputting a measurement result on a display along with the identification label.

According to certain embodiments of the present disclosure, an interface method for a measuring device includes: receiving at least one of a measurement result and identification label of a corresponding measuring device from a portable device by an information system for managing measurement data; and storing the received measurement result and identification label of the corresponding measuring device in a database.

According to certain embodiments of the present disclosure, an electronic device includes: at least one processor; a memory; and at least one program stored in the memory and configured to be executed by the at least one processor, wherein the program generates an image including at least one of a measurement result and identification label of the measuring device using a camera; extracts at least one of the measurement result and identification label of the measuring device from the generated image; and transmits the at least one of the extracted measurement result and identification label of the measuring device to an information system for managing measurement data.

According to certain embodiments of the present disclosure, a measuring device includes: a control unit for acquiring an identification label and performing a corresponding measurement process and outputting a measurement result on a display along with the identification label.

According to certain embodiments of the present disclosure, an information system for managing measurement data includes: an interface unit for receiving at least one of a measurement result and identification label of a corresponding measuring device from a portable device; and a control unit for storing the received measurement result and identification label of the corresponding measuring device in a database.

According to certain embodiments of the present disclosure, an interface method for a measuring device includes: generating, by a portable device, an image including at least one of a measurement result and identification label of the measuring device using a camera; transmitting the image including at least one of the measurement result and identification label of the measuring device to an information system; receiving information about at least one of the measurement result and identification label of the measuring device from the information system; and displaying the information about at least one of the measurement result and identification label of the measuring device.

According to certain embodiments of the present disclosure, an interface method for a measuring device, includes: receiving, by an information system, an image including at least one of a measurement result and identification label of the measuring device from a portable device; extracting at least one of the measurement result and identification label of the measuring device from the image; and transmitting at least one of the extracted measurement result and identification label of the measuring device to the portable device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a system for connecting a health measuring device to a health information system according to embodiments of the present disclosure;

FIG. 2 illustrates a portable device for providing an interface capable of communicating with a health information system 130 according to an embodiments of the present disclosure;

FIG. 3 illustrates a measuring device according to an embodiments of the present disclosure;

FIG. 4 illustrates a health information system according to an embodiments of the present disclosure;

FIGS. 5A and 5B illustrate a measurement result and an identification label displayed on a measuring device according to an exemplary embodiments of the present disclosure;

FIG. 6 illustrates a method of operating a measuring device according to embodiments of the present disclosure;

FIG. 7 illustrates a method of operating a portable device according to embodiments of the present disclosure; and

FIG. 8 illustrates a method of operating a health information system according to embodiments of the present disclosure.

### DETAILED DESCRIPTION

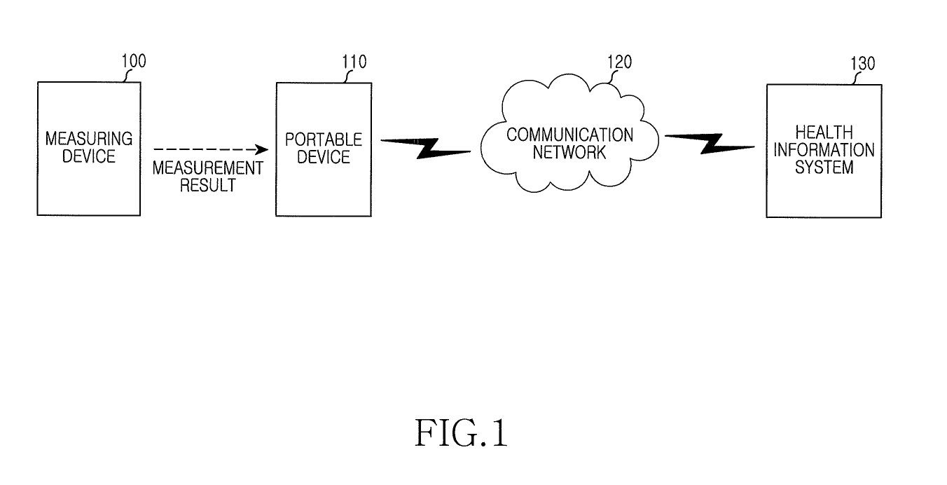

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Embodiments of the present disclosure will be described herein below with reference to the accompanying drawings. In the following description, detailed descriptions of well-known functions or configurations will be omitted because they would unnecessarily obscure the subject matter of the present disclosure. Also, the terms used herein are defined according to the functions of the present disclosure. Thus, the terms may vary depending on users' or operators' intentions or practices. Therefore, the terms used herein should be understood based on the descriptions made herein.

The present disclosure relates to a method, device and system for transmitting the measurement result of a measuring device to an information system. In particular, the present disclosure relates to an interface for a measuring device which is capable of displaying a measurement result in digits on the display of a portable device for collection of information.

Hereinafter, embodiments of the present disclosure will be described with reference to a medical measuring device and a health information system as examples, but can be applicable to other measuring devices.

FIG. 1 illustrates a configuration of a system for connecting a health measuring device to a health information system according to embodiments of the present disclosure.

Referring to FIG. 1, the system includes a measuring device 100 including a display for displaying a measurement result which can be read by at least one human and an identification label which is readable by a machine; a portable device 110 for communication with a health information system 130, image recognition and identification label recognition; and the health information system 130 for communicating with the portable device 110 through a communication network 120.

The measuring device 100 does not have an interface capable of communicating with the health information system 130. Therefore, according to the present disclosure, the portable device 110 captures a measurement result and an identification label displayed on the display of the measuring device 100 through a camera included in the portable device, extracts information about the measurement result and the identification label, and transmits the information to the health information system 130.

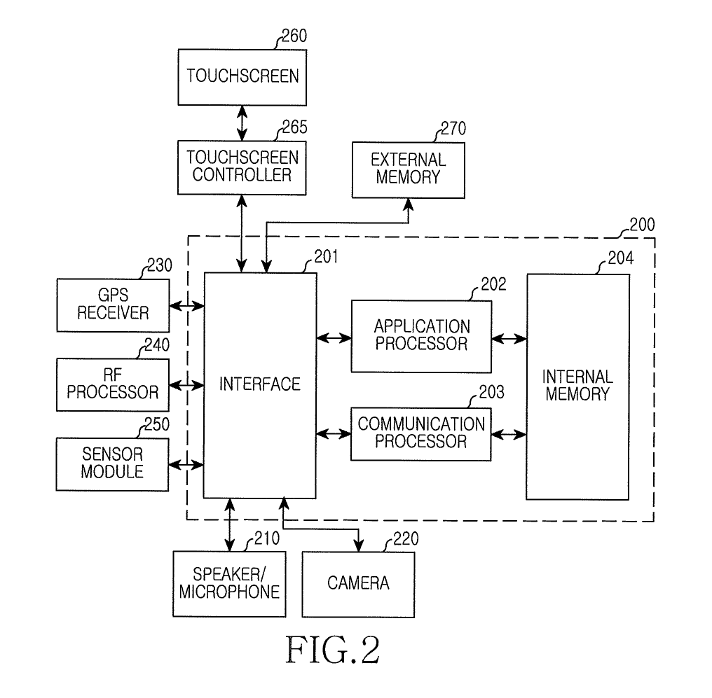

FIG. 2 illustrates a portable device for providing an interface capable of communicating with a health information system 130 according to embodiments of the present disclosure.

The portable device can include portable terminals, mobile phones, mobile pads, media players, tablet computers, handheld computers, personal digital assistants (PDAs), smart phones, and the like. Also, the portable device can be any portable electronic device including a combination of two or more functions of the above-mentioned devices.

Referring to FIG. 2, the portable device includes a controller 200, a speaker/microphone 210, a camera 220, a GPS receiver 230, an RF processor 240, a sensor module 250, a touchscreen 260, a touchscreen controller 265, and an external memory 270.

The controller 200 includes an interface 201, one or more processors 202 and 203, and an internal memory 240. In some cases, the controller 200 can also be referred to as a processor. The interface 201, the application processor 202, the communication processor 203, and the internal memory 204 can be separate units, or can be integrated on one or more integrated circuits.

The application processor 202 executes various software programs to perform various functions for the portable device, and the communication processor 203 performs processes and controls for voice communication and data communication. In addition to these general functions, the processors 202 and 203 execute a software module (also referred to as an instruction set) stored in the external memory 270 or the internal memory 204 and perform various functions corresponding to the software module. That is, the processors 202 and 203 perform the methods of the embodiments of the present disclosure in cooperation with software modules stored in the external memory 270 or the internal memory 203.

According to embodiments of the present disclosure, the application processor 202 focuses on and captures the display screen of the measuring device 100, which displays a measurement result and an identification label, using the camera 220. The application processor 202 stores the measurement result and identification label of the measuring device as images (the captured measurement result and identification label of the measuring device can be stored as one image or as the image of the display displaying the measurement result and an the image of the identification label, respectively), and extracts a first information from the image of the measurement result and the identification label captured by the camera 220. The first information is the unique code of the corresponding measuring device. The extraction of the unique code from the image can be implemented using an Optical Character Reader (OCR). If the identification label is implemented using a barcode or a Quick Response (QR) code, the extraction can be performed through barcode decoding or QR code decryption.

In addition, the application processor 202 checks whether additional information for extraction of a second information is included in the identification label and, when the additional information does not exist, requests and receives additional information from the health information system. The additional information includes a device model name, a measurement mode, a measurement unit (for example, heart rate in beats per minute, temperature gradation in Celsius/Fahrenheit, a blood pressure measuring device, a blood sugar location or the like) and locations of a variety of information (for example, a current measurement result, a measurement unit, a measurement mode or the like) related to the display of the measuring device.

Also, the application processor 202 extracts information (that is, second information) about the measurement result from the stored image using the additional information, transmits the first and second information to the health information system 130, stores the first and second information in the memories 204 and 270 and displays the extracted information about the measurement result, the measurement mode and the measurement unit in order to allow a user to view the information.

The interface 201 is connected to the touch screen controller 265 and to the external memory 270 of the portable device.

The sensor module 250 can be connected to the interface 201 to perform various functions. For example, a motion sensor and an optical sensor can be connected to the interface 201 to detect a motion of the portable device and detect light from the outside. In addition, other sensors such as a position measuring system, a temperature sensor, and a biosensor can be connected to the interface 201 to perform relevant functions.

The camera 220 can be connected through the interface 201 to the sensor module 250 to perform camera functions such as photographing and video clip recording. In particular, the camera 220 is used to capture the image of the display of the measuring device and the image of the identification label.

The RF processor 240 performs communication functions. For example, under the control of the communication processor 203, the RF processor converts an RF signal into a baseband signal and provides the baseband signal to the communication processor 203, or converts a baseband signal from the communication processor 203 into an RF signal prior to transmission. Herein, the communication processor 203 processes baseband signals according to various communication schemes. For example, the communication schemes can include, but not limited to, a GSM (Global System for Mobile Communication) communication scheme, an EDGE (Enhanced Data GSM Environment) communication scheme, a CDMA (Code Division Multiple Access) communication scheme, a W-CDMA (W-Code Division Multiple Access) communication scheme, an LTE (Long Term Evolution) communication scheme, an OFDMA (Orthogonal Frequency Division Multiple Access) communication scheme, a WiFi (Wireless Fidelity) communication scheme, a WiMax communication scheme, and/or a Bluetooth communication scheme.

In particular, the RF processor 240 is used to transmit the measurement information, at least partial information of the identification label to the health information system, and receive data about the measuring device from the health information system based on the at least partial information of the identification label.

The speaker/microphone 210 can perform audio stream input/output such as voice recognition, voice replication, digital recording, and phone functions. That is, the speaker/microphone 210 converts a voice signal into an electrical signal or coverts an electrical signal into a voice signal. Although not illustrated, an attachable/detachable earphone, a headphone, or a headset can be connected through an external port to the electronic device.

The touchscreen controller 265 can be connected to the touchscreen 260. For example, the touchscreen 260 and the touchscreen controller 265 can detect a touch, a motion, or a stop thereof by using multi-touch detection technologies including a proximity sensor array or other elements, as well as capacitive, resistive, infrared and surface acoustic wave technologies for determining one or more touch points with the touchscreen 260.

The touchscreen 260 provides an input/output interface between the electronic device and the user. That is, the touchscreen 260 transmits a user touch input to the electronic device. Also, the touchscreen 260 is a medium that displays the output from the electronic device to the user. That is, the touchscreen 260 displays a visual output to the user. The visual output can be represented by text, a graphic, a video, or a combination thereof.

According to the present disclosure, the portable device performs display through a screen when the image of the display and identification label of the measuring device captured by the camera 220 is output, and when information (for example, the measurement result from the measuring device, a device unique number included in the identification label, or the like) is extracted from the image of the display and identification label of the measuring device and output. Such a screen can be also a touchscreen for processing touch inputs.

The touchscreen 260 can use various display technologies. For example, the touchscreen 260 can use an LCD (liquid crystal display), an LED (Light Emitting Diode), an LPD (light emitting polymer display), an OLED (Organic Light Emitting Diode), an AMOLED (Active Matrix Organic Light Emitting Diode), or an FLED (Flexible LED).

The GPS receiver 230 converts signals received from satellites into information such as position, speed, and time. For example, the distance between a satellite and the GPS receiver is calculated by multiplying the velocity of light by a signal arrival time, and the position of a receiver is measured by triangulation by obtaining the accurate positions and distances of three satellites.

The external memory 270 or the internal memory 204 can include one or more high-speed random-access memories (RAMs), such as magnetic disk storage devices, one more nonvolatile memories, one or more optical storage devices, and/or one or more flash memories (for example, NAND flash memories or NOR flash memories).

The internal memory 204 stores software. Elements of the software include an operation system (OS) software module, a communication software module, a graphic software module, a user interface (UI) software module, an MPEG module, a camera software module, and one or more application software modules. Since the module that is an element of the software can be represented as a set of instructions, the module can be referred to as an instruction set. The module can also be referred to as a program.

In particular, the external memory 270 or the internal memory 204 stores the image of the measuring device including at least one of the display and the identification label.

The OS software includes various software elements for controlling general system operations. For example, general system operation controls include memory control/management, storage hardware (device) control/management, and power control/management. The OS software also performs a function for enabling smooth communication between various hardware elements (devices) and software elements (modules).

The communication software module can enable communication with other electronic devices (such as computers, servers, and/or portable terminals) through the RF processor 240. The communication software module includes a protocol structure corresponding to a relevant communication scheme.

The graphic software module includes various software elements for providing and displaying graphics on the touchscreen 260. The graphics include texts, web pages, icons, digital images, videos, and animations.

The user interface (UI) software module includes various software elements related to a user interface. Specifically, the UI software module includes information about how the state of a user interface changes and/or information about under what condition the state of a user interface changes.

The camera software module can include camera-related software elements that enable camera-related processes and functions. The application module includes a browser application, an e-mail application, an instant message application, a word processing application, a keyboard emulation application, an address book application, a touch list application, a widget application, a digital right management (DRM) application, a voice recognition application, a voice replication application, a position determining function application, a location-based service (LBS) application, and the like. The memories 270 and 204 can further include an additional module (instructions) in addition to the above-described modules. Also, in some cases, the memories 270 and 204 do not use some of the modules (instructions).

According to the present disclosure, the application module includes a series of instructions for providing an interface for transmitting the measurement result of the measuring device to a corresponding health information system.

For example, the application module is used to analyze the stored image of the identification label and extract information about the locations of a variety of information related to at least a device unique number, a device model, a measurement mode, and the display of the measuring device.

Also, the application module is used to analyze the stored image of the display of the measuring device and extract information about at least a measurement result, a measurement unit and a measurement mode. In addition, the application module can utilize information from the locations of the variety of information related to the display of the measuring device in order to improve the result of display image analysis and measurement information extraction. For example, information about the location of the measurement result guides the application module to a specific part of the image of the display for extraction of measurement information.

Instructions according to an embodiment of the present disclosure are executed to focus on and capture the display screen of the measuring device which displays a measurement result and an identification label using the camera 220, to store the measurement result and identification label of the measuring device as images (the captured measurement result and identification label of the measuring device can be stored as one image or as a display image corresponding to the measurement result and an identification label image respectively), and to extract the measurement result from the image captured by the camera 220 and first information from the identification label. The first information is the unique code of a corresponding measuring device. The extraction of the unique code from the image can be implemented using an Optical Character Reader (OCR). If the identification label is implemented using a barcode or a QR code, the extraction can be performed through barcode decoding or QR code decryption.

In addition, the instructions are executed to check whether additional information for extraction of second information is included in the identification label and, when the additional information does not exist, request and receive additional information from the health information system. The additional information includes a device model, a measurement mode, a measurement unit (for example, heart rate in beats per minute, temperature gradation C/F, blood pressure measuring device, blood sugar location or the like) and locations of a variety of information (for example, a current measurement result, a measurement unit, a measurement mode or the like) related to the display of the measuring device.

Also, the instructions are executed to extract information (that is, second information) about the measurement result from the stored image using the additional information, transmit the first and second information to the health information system 130, store the first and second information in the memories 204 and 270 and display the extracted information related to the measurement result, the measurement mode, and the measurement unit in order to allow a user to view the information.

In addition, various functions of the portable device according to the present disclosure, which have been described above and will be described below, can be implemented by any combination of hardware and/or software including one or more processings and/or an application-specific integrated circuit (ASIC).

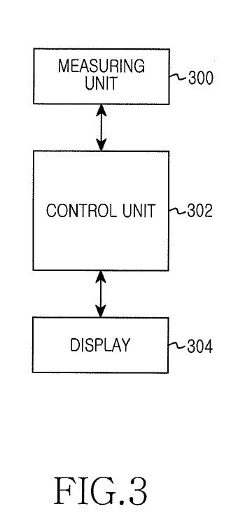

FIG. 3 illustrates a measuring device according to embodiments of the present disclosure.

Referring to FIG. 3, the measuring device includes a control unit 302, a measuring unit 300, and a display 304.

The measuring unit 300 performs one or more health related measurement, such as body temperature, blood pressure, heart rate, weight, height or blood sugar, and transmits the measurement result to the control unit. For example, the measuring unit 300 can measure blood pressure using a pressure sensor, measure a blood pressure signal corresponding to heart rate using an acoustic sensor or measure blood sugar by receiving the blood of a user and analyzing components included in the blood.

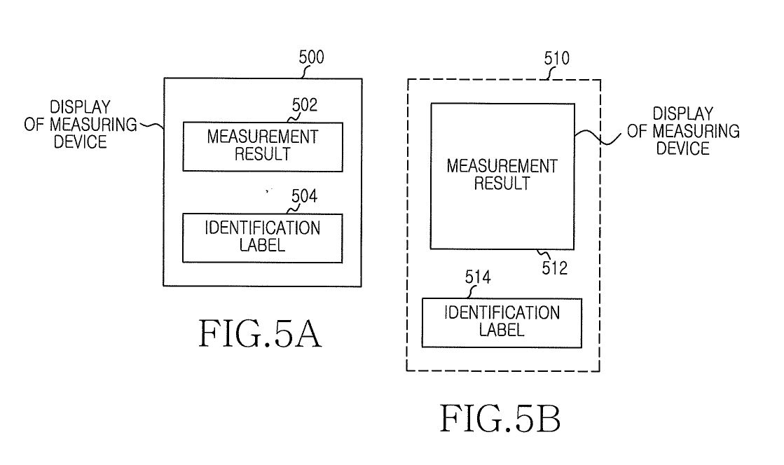

The control unit 302 receives measurement signals from the measuring unit 300, converts the measurement signals into digits which can be recognized by a user and displays the converted digits on the display 304. Also, the control unit 302 displays the identification label including the unique code of the measuring device 100 along with the measurement result through the display 304. (See FIG. 5A).

Depending on the capabilities of the measuring device 100 and the display 304, the identification label of the measuring device can be located at various locations with respect to display 304. The measuring device 100 displays at least one of the measurement result and the identification label simultaneously or in order.

In certain embodiments, if the display 304 can not display the identification label 504, the identification label can be prepared in advance and attached to the measuring device at a location, preferably adjacent to the display. Therefore, the identification label and the display 304 can be registered as an image by the camera 220 of the portable device. In certain embodiments, the identification label can be attached to the measuring device 100 at a location conveniently and easily approachable by an unskilled user having the camera 201 of the portable device 200 in order for the user to easily register information about the display 304 and the identification label of the measuring device. For example, the display 304 can be located on the front panel of the measuring device 100, and the identification label can be located at the upper end or side panel of the measuring device 100.

The identification label of the measuring device can be an image displayed in the display 304. The image of the identification label is easily recognized or read through the camera 220 of the portable device. For example, the identification label can be configured using a machine-readable code, a QR code, a barcode or the like.

In a case in which the measuring device 100 cannot display the identification label on the display 304, the identification label can be provided to the measuring device 100 as an additional component. For example, the identification label can be printed on paper and then attached to the panel of the measuring device.

The identification label can include the unique code of the measuring device 100 which is registered in the health information system 130. For example, a barcode type of identification label can include an encoded device unique number for the health information system 130.

Also, if the identification label is generated using a machine-readable code including any text information (for example, a QR code), the identification label can have additional information about the measuring device 100. In this case, the identification label can include additional information, such as a device unique number, a device model, a measurement mode, a measurement unit (for example, heart rate in beats per minute, temperature gradation C/F (Centigrade/Fahrenheit), a blood pressure measuring device, a blood sugar measurement location or the like) and locations of variety of information (for example, a current measurement result, a measurement unit, a measurement mode or the like) related to the display 304 of the measuring device 100, or the like.

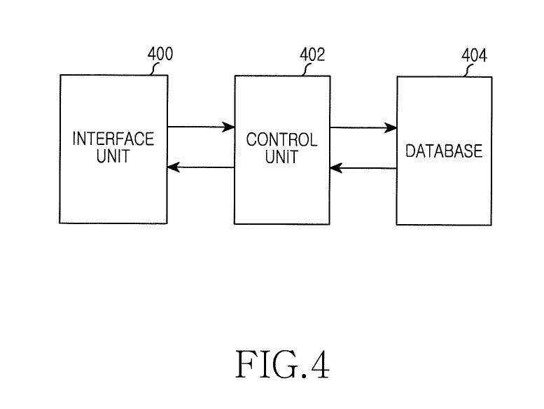

FIG. 4 illustrates a health information system according to embodiments of the present disclosure.

Referring to FIG. 4, the health information system includes an interface unit 400, a control unit 402, and a database 404.

The interface unit 400 can communicate with the portable device 110. The interface unit 400 receives information from the database 404 and transmits the information to the portable device 110.

The control unit 402 receives at least partial information from the identification label including at least the unique identifier of the measuring device 100 through the interface unit 400. Based on the unique identifier of the measuring device 100, the control unit 402 transmits information about the measuring device 100 to the portable device 110 using the given unique identifier. Such information can include additional information, such as a device model, a measurement mode, a measurement unit (for example, heart rate in beats per minute, temperature gradation C/F (Centigrade/Fahrenheit), a blood pressure measuring device, a blood sugar location or the like) and locations of a variety of information (for example, a current measurement result, a measurement unit, a measurement mode or the like) related to the display 304 of the measuring device 100. When the additional information is not included in the identification label or cannot be decoded from the identification label, the additional information can be provided to the portable device 110 in order to improve the result of display image analysis and measurement information extraction in the portable device.

Also, the control unit 402 can receive measurement information extracted from the image of the display 304 from the portable device 110. Such measurement information can be received along with the unique number of the measuring device which is extracted from the identification label by the portable 110. Further, the measurement information can include a measurement mode and a measurement unit.

The database 404 stores the measurement information received from the portable device 110 for additional processing.

FIGS. 5A and 5B illustrate a measurement result and an identification label displayed on a measuring device according to an exemplary embodiment of the present disclosure.

Referring to FIG. 5A, the measurement result 502 and identification label 504 of the measuring device can be displayed on a display 500 simultaneously or in order.

Referring to FIG. 5B, the measurement result 502 of the measuring device 510 can be displayed on the display 512 and the identification label 504 of the measuring device 510 can be indicated on the panel 514 of the measuring device rather than the display 500.

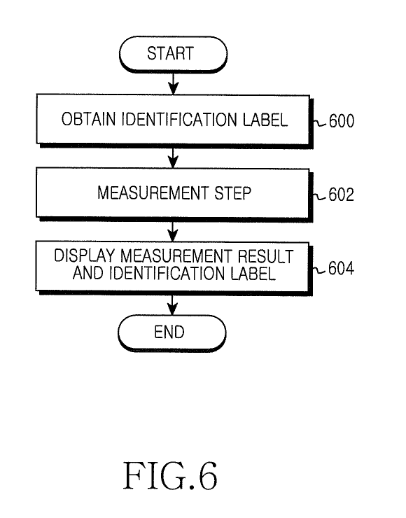

FIG. 6 illustrates a method of operating a measuring device according to embodiments of the present disclosure.

Referring to FIG. 6, in block 600, the measuring device acquires an identification label. The identification label is the unique code of the measuring device given by a manufacturer. Also, the identification label can be displayed on the display 500, 512 of the measuring device or be attached to the panel 514 of the measuring device.

According to implementation, the identification label of the measuring device can be implemented in an image form, and is easily recognized or read through the camera 220 of the portable device. For example, the identification label can be configured using a machine-readable code, a QR code, a barcode or the like. That is, when the measuring device 100 does not have a display on which the identification label can be displayed, the identification label is generated as a physical object (for example, printed on paper or foil) and is then attached to the measuring device separately.

The identification label can include the unique code of the measuring device 100 which is registered in the health information system 130. For example, a barcode type of identification label can include an encoded device unique number of the measuring device 100 for the health information system 130.

Also, if the identification label is generated using a machine-readable code including any text information (for example, QR code), the identification label can have additional information about the measuring device. In this case, the identification label can include additional information, such as a device unique number, a device model, a measurement mode, a measurement unit (for example, heart rate in beats per minute, temperature gradation C/F (Centigrade/Fahrenheit), a blood pressure measuring device, a blood sugar location or the like) and locations of a variety of information (for example, a current measurement result, a measurement unit, a measurement mode or the like) related to the display 304 of the measuring device 100.

Also, the unique code or unique number of the measuring device 100 is registered in the health information system 130.

In block 602, the measuring device 100 performs a measurement process of a user. For example, health related measurement, such as body temperature, blood pressure, heart rate, weight, height, blood sugar or the like, is performed.

In block 604, the measuring device displays identification label information including the measurement result and the unique code of the measuring device.

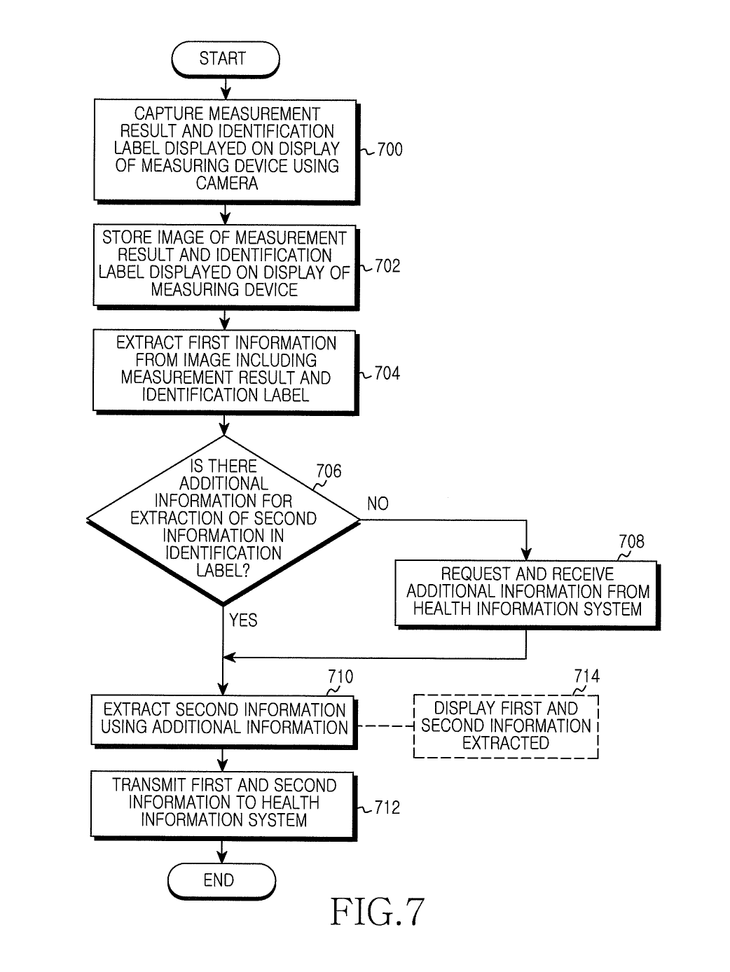

FIG. 7 illustrates a process of operating a portable device according to embodiments of the present disclosure.

Referring to FIG. 7, in block 700, the portable device 110, using the camera 220 included therein, focuses on and captures the display screen 500, 512 of the measuring device which displays a measurement result and an identification label.

In block 702, the portable device 110 stores the measurement result and identification label of the measuring device as images. The measurement result and identification label of the measuring device can be stored as an image or as the image of the display for displaying the measurement result and the image of the identification label respectively.

That is, if the measurement result and identification label of the measuring device can be registered as an image, a user performs capturing using a camera 220 in order to register an image including the display 500 and the identification label 504 and store the image in the memories 204 and 270.

If the measurement result and identification label of the measuring device cannot be registered as an image, the portable device 110 registers and stores the image of the identification label in the memories 204 and 270 and registers and stores the image of the display in the memories 204 and 270. Depending on implementation, the registration order of the image of the display and the image of the identification label can alternate. That is, the user first registers and stores the image of the display and then registers and stores the image of the identification label.

In block 704, the portable device 110 extracts the measurement result from the image captured by the camera 220 and first information from the identification label. The first information is the unique code of a corresponding measuring device 100. The extraction of the unique code from the image can be implemented using an Optical Character Reader (OCR). If the identification label is implemented using a barcode or a QR code, extraction can be performed using barcode decoding, QR code decryption or the like.

In block 706, the portable device 110 checks whether additional information for extraction of second information is included in the identification label. When the additional information exists, the portable device 110 proceeds to block 710 and, when the additional information does not exist, the portable device 110 proceeds to block 708. In block 708, the portable device 110 requests and receives the additional information from the health information system 130. The additional information can include a device model, a measurement mode, a measurement unit (for example, heart rate in beats minute, temperature gradation C/F (Centigrade/Fahrenheit), a blood pressure measuring device, a blood sugar location or the like) and locations of a variety of information (for example, a current measurement result, a measurement unit, a measurement mode or the like) related to the display of the measuring device.

In certain embodiments, when not having a function of recognizing characters from an image, the portable device 110 transmits an image corresponding to the measurement result and identification label of the measuring device to the health information system 130 and receives information resulting from the analysis of the health information system 130. That is, information about a measurement result, a measurement mode and a measurement unit can be extracted from the image.

In block 710, the portable device 110 extracts information (that is, second information) about the measurement result from the stored image using the additional information.

That is, if the identification label does not include additional information about the measurement mode and measurement unit of the measuring device and the locations of a variety of information related to the display of the measuring device, the portable device 110 transmits a request for the additional information to the health information system 130. Otherwise, the portable device 110 extracts information about the measurement result, the measurement mode and the measurement unit from the stored image using the additional information extracted from the identification label.

In block 712, the portable device 110 transmits the first and second information to the health information system 130. Although not illustrated in drawings, the first and second information are stored in the memories 204 and 270.

In block 714, the portable device 110 displays the extracted information about the measurement result, the measurement mode and the measurement unit to allow the user to view the information.

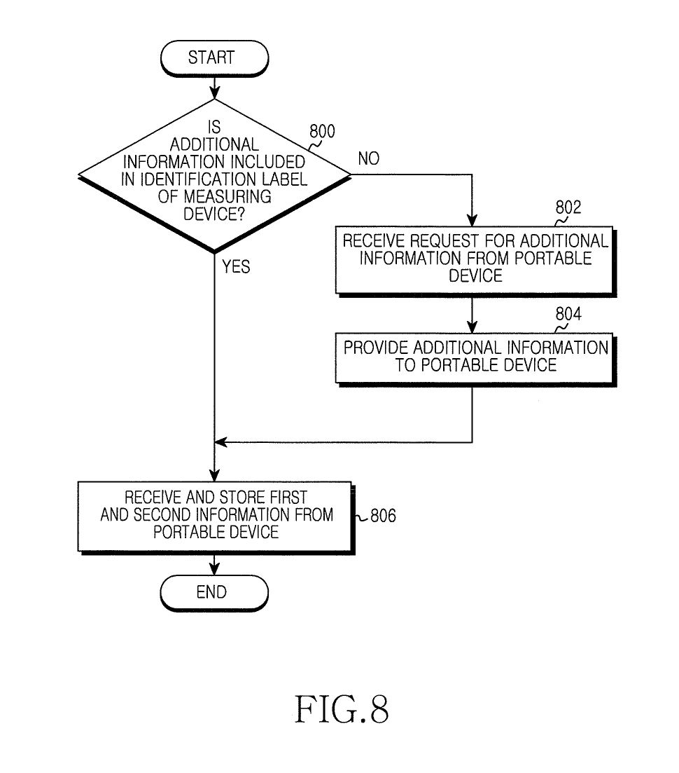

FIG. 8 illustrates an operation flow of a health information system according to embodiments of the present disclosure.

Referring to FIG. 8, in block 800, the health information system 130 determines whether additional information is not included in the identification label of the measuring device. When the additional information is not included in the identification label of the measuring device, the health information system 130 proceeds to block 802. In block 802, the health information system 130 receives a request for additional information from the portable device 110. In block 804, the health information system provides respective additional information about the locations of a variety of information about the measurement mode, measurement unit and display of the measuring device. On the other hand, when the additional information is included in the identification label of the measuring device, the health information system proceeds to block 806.

In block 806, the health information system 130 receives the first and second information related to a corresponding measuring device from the portable device 110. The first information is the unique code of the measuring device and the second information is the measurement result of the measuring device.

The methods according to the embodiments described in the claims and/or specification of the present disclosure can be implemented by hardware, software, or a combination thereof.

When the methods are implemented by software, a computer-readable storage medium can be provided to store one or more programs (software modules). The one or more programs stored in the computer-readable storage medium can be configured for execution by one or more processors in an electronic device. The one or more programs can include instructions for causing the electronic device to execute the methods according to the exemplary embodiments described in the claims and/or specification of the present disclosure.

These programs (software modules or software) can be stored in random access memories (RAMs), nonvolatile memories including flash memories, read only memories (ROMs), electrically erasable programmable ROMs (EEPROMs), magnetic disc storage devices, compact disc-ROMs (CD-ROMs), digital versatile discs (DVDs), other types of optical storage devices, or magnetic cassettes. Also, the programs can be stored in a memory configured by a combination of some or all of such storage devices. Also, each of the memories can be provided in plurality.

Also, the programs can be stored in an attachable storage device that can be accessed by the electronic device through a communication network such as Internet, Intranet, local area network (LAN), wireless LAN (WLAN), or storage area network (SAN), or through a communication network configured by a combination thereof. This storage device can be accessed by the electronic device through an external port.

Also, a separate storage device on a communication network can be accessed by a portable electronic device.

As described above, the present disclosure captures the measurement result and identification label of a measuring device using the camera of a portable device, analyzes the captured image and then transmits the analysis result through the communication interface of the portable device, thereby providing an advantage in that the measurement result of the measuring device having no interface for transmission of the measurement result can be transmitted to an information system.

Also, special training is not required to connect the measuring device 110 to the information system 130.

While the invention has been shown and described with reference to certain embodiments thereof, it will be understood by those skilled in the art that various changes in form and details can be made therein without departing from the spirit and scope of the disclosure as defined by the appended claims. Therefore, the scope of the invention is defined not by the detailed description of the disclosure but by the appended claims, and all differences within the scope will be construed as being included in the present disclosure.

What is claimed is:

1. An interface method for a measuring device, comprising:
generating, by a portable device, an image including at least one of a measurement result and an identification label of the measuring device using a camera;
extracting, by the portable device, at least one of the measurement result and identification label of the measuring device from the generated image; and
transmitting, by the portable device, the at least one of the extracted measurement result and identification label of the measuring device to an information system for managing measurement data.

2. The interface method of claim 1, wherein the identification label is one of:
a unique code for identification of the measuring device displayed on a display of the measuring device; and
printed and attached to the measuring device.

3. The interface method of claim 2, wherein the identification label is one of a barcode and a QR code.

4. The interface method of claim 1, wherein extracting, by the portable device, at least one of the measurement result and identification label of the measuring device from the generated image includes:
extracting information included in the identification label from the generated image; and
extracting information corresponding to the measurement result from the generated image based on the information included in the identification label.

5. The interface method of claim 4, wherein the information included in the identification label includes at least one of:
a unique number,
a device model name,
a measurement mode,
a measurement unit, and
information about a location of information displayed on the measuring device.

6. The interface method of claim 1, wherein extracting, by the portable device, at least one of the measurement result and identification label of the measuring device from the generated image includes:
extracting information included in the identification label from the generated image;
determining whether additional information is included in the identification label;
when the additional information is not included in the identification label, requesting additional information related to the measuring device from the information system;
receiving the additional information from the information system; and
extracting information corresponding to the measurement result from the generated image using the additional information received from the information system.

7. The interface method of claim 1, further comprising storing, by the portable device, the at least one of:
the extracted measurement result, and
the identification label of the measuring device.

8. The interface method of claim 1, further comprising displaying, by the portable device, the at least one of the extracted measurement result and the identification label of the measuring device.

9. An interface method for a measuring device, comprising:
acquiring an identification label by a measuring device;
performing, by the measuring device, a corresponding measurement process; and
outputting a measurement result on a display along with the identification label.

10. The interface method of claim 9, wherein the identification label is a unique code for identification of the measuring device and is one of:
displayed on a display of the measuring device, and
printed and attached to the measuring device.

11. The interface method of claim 10, wherein the identification label is one of a barcode and a QR code.

12. An interface method for a measuring device, comprising:
Receiving, by an information system for managing measurement data, at least one of a measurement result and identification label of a corresponding measuring device from a portable device; and
storing the received measurement result and identification label of the corresponding measuring device in a database.

13. The interface method of claim 12, further comprising receiving a request for additional information about the corresponding measuring device from the portable device; and
providing the additional information about the corresponding measuring device to the portable device.

14. The interface method of claim 12, wherein the identification label is a unique code for identification of the measuring device and is one of:
displayed on a display of the measuring device, and
printed and attached to the measuring device.

15. The interface method of claim 14, wherein the identification label is one of a barcode and a QR code.

16. The interface method of claim 12, wherein the additional information about the corresponding measuring device includes at least one of:
a unique number,
a device model name,
a measurement mode,
a measurement unit, and
information about a location of information displayed on the measuring device.

17. An electronic device comprising:
at least one processor;
a memory; and
at least one program stored in the memory and configured to be executed by the at least one processor,
wherein when the at least one processor executes the program, the program causes the at least one processor to:
generate an image including at least one of a measurement result and identification label of the measuring device using a camera;
extract at least one of the measurement result and identification label of the measuring device from the generated image; and
transmit the at least one of the extracted measurement result and identification label of the measuring device to an information system for managing measurement data.

18. The electronic device of claim 17, wherein the identification label is a unique code for identification of the measuring device and is one of:
displayed on a display of the measuring device, and
printed and attached to the measuring device.

19. The electronic device of claim 18, wherein the identification label is one of a barcode and a QR code.

20. The electronic device of claim 17, wherein the program that causes the at least one processor to extract at least one of the measurement result and identification label of the measuring device from the generated image further causes the at least one processor to:
extract information included in the identification label from the generated image; and
extract information corresponding to the measurement result from the generated image based on the information included in the identification label.

21. The electronic device of claim 20, wherein the information included in the identification label includes at least one of:
a unique number,
a device model name,
a measurement mode,
a measurement unit, and
information about a location of information displayed on the measuring device.

22. The electronic device of claim 17, wherein the program that causes the at least one processor to extract at least one of the measurement result and identification label of the measuring device from the generated image further causes the at least one processor to:
extract information included in the identification label from the generated image;
determine whether additional information is included in the identification label;
when the additional information is not included in the identification label, request additional information related to the measuring device from the information system;
receive the additional information from the information system; and
extract information corresponding to the measurement result from the generated image using the additional information received from the information system.

23. The electronic device of claim 17, wherein the program further causes the at least one processor to stores the at least one of the extracted measurement result and identification label of the measuring device.

24. The electronic device of claim 17, wherein the program further causes the at least one processor to display the at least one of the extracted measurement result and identification label of the measuring device.

25. A measuring device comprising:
a control unit configured to:
acquire an identification label;
perform a corresponding measurement process; and
output a measurement result on a display along with the identification label.

26. The measuring device of claim 25, wherein the identification label is a unique code for identification of the measuring device and is one of:
displayed on a display of the measuring device, and
printed and attached to the measuring device.

27. The measuring device of claim 26, wherein the identification label is one of a barcode and a QR code.

28. An information system for managing measurement data, comprising:
an interface unit configured to receive at least one of:
a measurement result, and
identification label of a corresponding measuring device from a portable device; and
a control unit configured to store the received measurement result and identification label of the corresponding measuring device in a database.

29. The information system of claim 28, wherein the interface unit is configured to:
receive a request for additional information about the corresponding measuring device from the portable device; and
provide the additional information about the corresponding measuring device to the portable device.

30. The information system of claim 28, wherein the identification label is a unique code for identification of the measuring device and is one of:
displayed on a display of the measuring device, and
printed and attached to the measuring device.

31. The information system of claim 30, wherein the identification label is one of a barcode and a QR code.

32. The information system of claim 28, wherein the additional information about the corresponding measuring device includes at least one of:
a unique number,
a device model name,
a measurement mode,
a measurement unit, and
information about a location of information displayed on the measuring device.

33. An interface method for a measuring device, comprising:
generating, by a portable device, an image including at least one of a measurement result and identification label of the measuring device using a camera;
transmitting the image including at least one of the measurement result and identification label of the measuring device to an information system;
receiving information about at least one of the measurement result and identification label of the measuring device from the information system; and
displaying the information about at least one of the measurement result and identification label of the measuring device.

34. An interface method for a measuring device, comprising:
receiving, by an information system, an image including at least one of a measurement result and identification label of the measuring device from a portable device;
extracting at least one of the measurement result and identification label of the measuring device from the image; and
transmitting at least one of the extracted measurement result and identification label of the measuring device to the portable device.
